(19) United States
(12) Patent Application Publication
(10) Pub. No.: US 2024/0319783 A1
(43) Pub. Date: Sep. 26, 2024

(54) ELECTRONIC DEVICE AND CHARGING METHOD USING SAME

(71) Applicant: Samsung Electronics Co., Ltd., Suwon-si (KR)

(72) Inventors: Kwonchon KWAK, Suwon-si (KR); Wookwang LEE, Suwon-si (KR); Jinyoung AHN, Suwon-si (KR)

(21) Appl. No.: 18/680,135

(22) Filed: May 31, 2024

Related U.S. Application Data
(63) Continuation of application No. PCT/KR2022/015240, filed on Oct. 11, 2022.

(30) Foreign Application Priority Data
Dec. 16, 2021 (KR) 10-2021-0180404

(51) Int. Cl. G06F 1/3296; G06F 1/3287; H02J 7/00

(52) U.S. Cl. CPC G06F 1/3296; G06F 1/3287; H02J 7/00034; H02J 7/0049; H02J 7/00714; H02J 7/007182

(57) ABSTRACT

An electronic device is provided. The electronic device includes a battery that supplies power to the electronic device, a power management integrated circuit (PMIC) which controls power required in the electronic device, a software battery charging management circuit that performs a charging management function of the battery, a software power saving management circuit that manages standby power of a plurality of circuits in the electronic device, memory storing one or more computer programs, and one or more processors communicatively coupled to the battery, the PMIC, the software battery charging management circuit, and software power saving management circuit, wherein the one or more computer programs include computer-executable instructions that, when executed by the one or more processors, cause the electronic device to, in response to identifying that a charger is connected to the electronic device, boot a system of the electronic device, control at least one circuit in the electronic device to operate in a sleep state for power saving by using the software power saving management circuit, charge the battery while the system of the electronic device is in an off state, in response to identifying that a charging state of the battery is not a fully charged state, charge the battery with a first voltage and/or a first current, in response to identifying that the charging state of the battery is the fully charged state, block power supply to the battery, and control power to be supplied circuit with a second voltage set lower than the first voltage and/or a second current set lower than the first current to at least one circuit in the electronic device, wherein the software battery charging management circuit and/or software power saving management circuit are/is implemented on the one or more processors.

### CROSS-REFERENCE TO RELATED APPLICATION(S)

This application is a continuation application, claiming priority under § 365(c), of an International application No. PCT/KR2022/015240, filed on Oct. 11, 2022, which is based on and claims the benefit of a Korean patent application number 10-2021-0180404, filed on Dec. 16, 2021, in the Korean Intellectual Property Office, the disclosure of which is incorporated by reference herein in its entirety.

### BACKGROUND

### 1. Field

The disclosure relates to an electronic device and a charging method using the same.

### 2. Description of Related Art

An electronic device may include a battery to provide power needed to perform various functions. The electronic device can charge the battery by receiving power from a power transmitting device wiredly or wirelessly.

Recently, due to environmental issues and requests for energy reduction, efforts are increasing to improve standby power when a portable device is connected to power in a system off state, and people are paying attention.

In the case of the portable device (e.g., a note personal computer (PC)), an embedded controller (EC) performs power management, keyboard management, charger function management, battery function management, and the like. The embedded controller (EC) uses always-on power, and when variable charging power is supplied to the system, the system turns on and can start charging and power management.

The above information is presented as background information only to assist with an understanding of the disclosure. No determination has been made, and no assertion is made, as to whether any of the above might be applicable as prior art with regard to the disclosure.

### SUMMARY

The use of the embedded controller (EC) in the electronic device may increase the complexity of circuits within the electronic device, and the repair of the embedded controller (EC) may cause an increase in the unit cost of the electronic device.

In addition, upon charging while the electronic device's system power is off, the power of an application processor (AP) is turned off, but it may be difficult to turn off the power of the embedded controller (EP) which is an always-on chip. Therefore, while the electronic device is charging, leakage current may occur and also standby power may increase. Here, the standby power may refer to the battery charging power and the system consumption power of the electronic device.

Additionally, upon charging while the system of the electronic device is off, the power of the AP may be off, but the AP may need to be booted to deliver information (e.g., battery charging state, error state) on the display. In this process, time delay may occur.

Aspects of the disclosure are to address at least the above-mentioned problems and/or disadvantages and to provide at least the advantages described below. Accordingly, an aspect of the disclosure is to provide an electronic device and a charging method using the same.

Additional aspects will be set forth in part in the description which follows and, in part, will be apparent from the description, or may be learned by practice of the presented embodiments.

In accordance with an aspect of the disclosure, an electronic device is provided. The electronic device includes a battery that supplies power to the electronic device, a power management integrated circuit (PMIC) that controls power required in the electronic device, a software battery charging management circuit that performs a charging management function of the battery, a software power saving management circuit that manages standby power of a plurality of circuits in the electronic device, memory storing one or more computer programs, and one or more processors communicatively coupled to the battery, the PMIC, the software battery charging management circuit, and software power saving management circuit, wherein the one or more computer programs include computer-executable instructions that, when executed by the one or more processors, cause the electronic device to, in response to identifying that a charger is connected to the electronic device, boot a system of the electronic device, control at least one circuit in the electronic device to operate in a sleep state for power saving by using the software power saving management circuit, and charge the battery while the system of the electronic device is in an off state, in response to identifying that a charging state of the battery is not a fully charged state, charge the battery with a first voltage and/or a first current, in response to identifying that the charging state of the battery is the fully charged state, block power supply to the battery, and control power to be supplied with a second voltage set lower than the first voltage and/or a second current set lower than the first current to at least one circuit in the electronic device, wherein the software battery charging management circuit and/or the software power saving management circuit are/is implemented in the one or more processors.

In accordance with another aspect of the disclosure, a charging method of an electronic device is provided. The method includes, in response to identifying that a charger is connected to the electronic device, booting a system of the electronic device, causing at least one circuit in the electronic device to enter a sleep state for power saving by using a software power saving management circuit that manages standby power of a plurality of circuits in the electronic device, and charging a battery that supplies power to the electronic device while the system of the electronic device is in an off state, in response to identifying that a charging state of the battery is not a fully charged state, charging the battery with a first voltage and/or a first current, and in response to identifying that the charging state of the battery is the fully charged state, blocking power supply to the battery, and controlling power to be supplied with a second voltage set lower than the first voltage and/or a second current set lower than the first current to at least one circuit in the electronic device, wherein the electronic device further includes a software battery charging management circuit, that performs a charging management function of the battery, and/or the software power saving management circuit are/is implemented in one or more processors.

According to various embodiments of the disclosure, the electronic device can improve standby power by using a power management integrated circuit (PMIC), which is hardware, and using a software power saving management circuit and a software battery charging management circuit, without using an embedded controller (EC) which always consumes current.

According to various embodiments of the disclosure, the electronic device does not use the embedded controller (EC), so circuits within the electronic device can be made uncomplicated, and the cost of repairing the embedded controller (EC) can be reduced.

According to various embodiments of the disclosure, the electronic device can operate a circuit in an application processor (AP) even in a system off state by using other components instead of the embedded controller (EC), and can also prevent delays due to booting of the AP in situations where information (e.g., battery charging state, error state) is delivered to a display.

In accordance with another aspect of the disclosure, one or more non-transitory computer-readable storage media storing computer-executable instructions that, when executed by one or more processors of an electronic device, cause the electronic device to perform operations are provided. The operations include, in response to identifying that a charger is connected to the electronic device, booting a system of the electronic device, causing at least one circuit in the electronic device to enter a sleep state for power saving by using a software power saving management circuit that manages standby power of a plurality of circuits in the electronic device, and charging a battery that supplies power to the electronic device while the system of the electronic device is in an off state, in response to identifying that a charging state of the battery is not a fully charged state, charging the battery with a first voltage and/or a first current, and in response to identifying that the charging state of the battery is the fully charged state, blocking power supply to the battery, and controlling power to be supplied with a second voltage set lower than the first voltage and/or a second current set lower than the first current to at least one circuit in the electronic device, wherein the electronic device further includes a software battery charging management circuit, that performs a charging management function of the battery, and/or the software power saving management circuit are/is implemented in one or more processors.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a charging system of an electronic device according to an embodiment of the disclosure;

FIG. 3 is a block diagram illustrating a charging system of an electronic device according to an embodiment of the disclosure;

FIG. 4 is a block diagram illustrating an electronic device according to an embodiment of the disclosure;

FIG. 5 illustrates a charging process of an electronic device according to an embodiment of the disclosure; and

FIG. 6 is a flow chart illustrating a charging method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

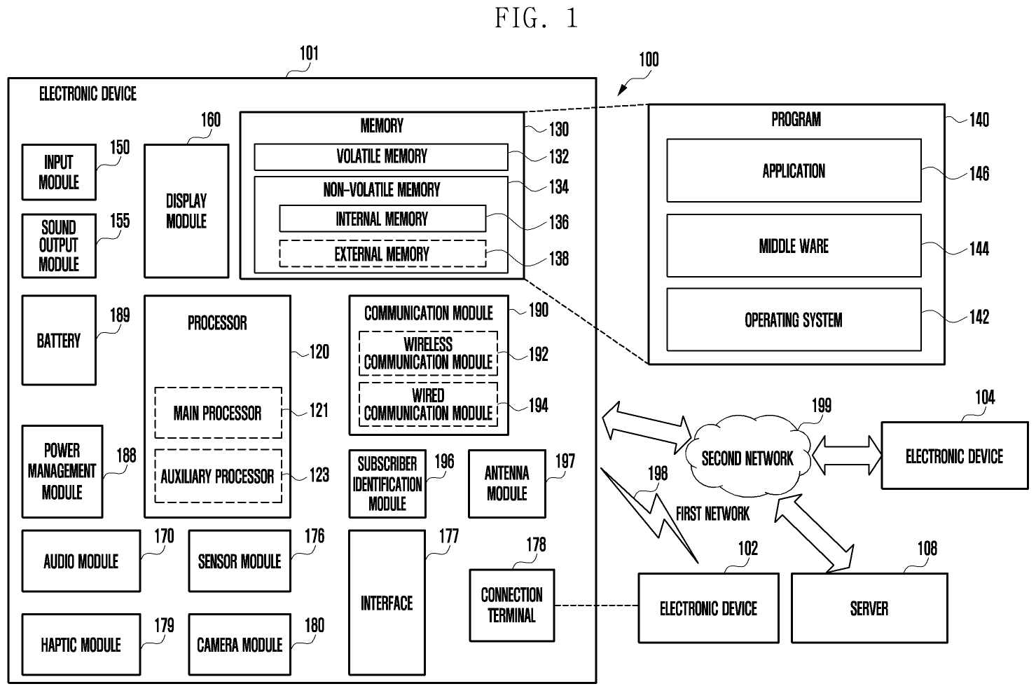

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input circuit 150, a sound output circuit 155, a display circuit 160, an audio circuit 170, a sensor circuit 176, an interface 177, a connecting terminal 178, a haptic circuit 179, a camera circuit 180, a power management circuit 188, a battery 189, a communication circuit 190, a subscriber identification circuit (SIM) 196, or an antenna circuit 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor circuit 176, the camera circuit 180, or the antenna circuit 197) may be implemented as a single component (e.g., the display circuit 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor circuit 176 or the communication circuit 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display circuit 160, the sensor circuit 176, or the communication circuit 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera circuit 180 or the communication circuit 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor circuit 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input circuit 150 may receive a command or data to be used by another component (e.g., the processor 120) of the electronic device 101, from the outside (e.g., a user) of the electronic device 101. The input circuit 150 may include, for example, a microphone, a mouse, a keyboard, a key (e.g., a button), or a digital pen (e.g., a stylus pen).

The sound output circuit 155 may output sound signals to the outside of the electronic device 101. The sound output circuit 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display circuit 160 may visually provide information to the outside (e.g., a user) of the electronic device 101. The display circuit 160 may include, for example, a display, a hologram device, or a projector and control circuitry to control a corresponding one of the display, hologram device, and projector. According to an embodiment of the disclosure, the display circuit 160 may include a touch sensor adapted to detect a touch, or a pressure sensor adapted to measure the intensity of force incurred by the touch.

The audio circuit 170 may convert a sound into an electrical signal and vice versa. According to an embodiment of the disclosure, the audio circuit 170 may obtain the sound via the input circuit 150, or output the sound via the sound output circuit 155 or a headphone of an external electronic device (e.g., the external electronic device 102) directly (e.g., wiredly) or wirelessly coupled with the electronic device 101.

The sensor circuit 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor circuit 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic circuit 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic circuit 179 may include, for example, a motor, a piezoelectric element, or an electric stimulator.

The camera circuit 180 may capture a still image or moving images. According to an embodiment of the disclosure, the camera circuit 180 may include one or more lenses, image sensors, image signal processors, or flashes.

The power management circuit 188 may manage power supplied to the electronic device 101. According to one embodiment of the disclosure, the power management circuit 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication circuit 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication circuit 190 may include one or more communication processors that are operable independently from the processor 120 (e.g., the application processor (AP)) and supports a direct (e.g., wired) communication or a wireless communication. According to an embodiment of the disclosure, the communication circuit 190 may include a wireless communication circuit 192 (e.g., a cellular communication circuit, a short-range wireless communication circuit, or a global navigation satellite system (GNSS) communication circuit) or a wired communication circuit 194 (e.g., a local area network (LAN) communication circuit or a power line communication (PLC) circuit). A corresponding one of these communication circuits may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication circuits may be implemented as a single component (e.g., a single chip), or may be implemented as multi components (e.g., multi chips) separate from each other. The wireless communication circuit 192 may identify and authenticate the electronic device 101 in a communication network, such as the first network 198 or the second network 199, using subscriber information (e.g., international mobile subscriber identity (IMSI)) stored in the subscriber identification circuit 196.

The wireless communication circuit 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication circuit 192 may support a high-frequency band (e.g., the millimeter wave (mm Wave) band) to achieve, e.g., a high data transmission rate. The wireless communication circuit 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication circuit 192 may support various requirements specified in the electronic device 101, an external electronic device (e.g., the external electronic device 104), or a network system (e.g., the second network 199). According to an embodiment of the disclosure, the wireless communication circuit 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna circuit 197 may transmit or receive a signal or power to or from the outside (e.g., the external electronic device) of the electronic device 101. According to an embodiment of the disclosure, the antenna circuit 197 may include an antenna including a radiating element including a conductive material or a conductive pattern formed in or on a substrate (e.g., a printed circuit board (PCB)). According to an embodiment of the disclosure, the antenna circuit 197 may include a plurality of antennas (e.g., array antennas). In such a case, at least one antenna appropriate for a communication scheme used in the communication network, such as the first network 198 or the second network 199, may be selected, for example, by the communication circuit 190 (e.g., the wireless communication circuit 192) from the plurality of antennas. The signal or the power may then be transmitted or received between the communication circuit 190 and the external electronic device via the selected at least one antenna. According to an embodiment of the disclosure, another component (e.g., a radio frequency integrated circuit (RFIC)) other than the radiating element may be additionally formed as part of the antenna circuit 197.

According to various embodiments of the disclosure, the antenna circuit 197 may form a mmWave antenna circuit. According to an embodiment of the disclosure, the mm Wave antenna circuit may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “circuit” may include a unit implemented in hardware, software, or firmware, and may interchangeably be used with other terms, for example, “logic,” “logic block,” “part,” or “circuitry”. A circuit may be a single integral component, or a minimum unit or part thereof, adapted to perform one or more functions. For example, according to an embodiment of the disclosure, the circuit may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a circuit or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., circuits or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the circuit, the program, or another component may be carried out sequentially, in parallel, repeatedly, or heuristically, or one or more of the operations may be executed in a different order or omitted, or one or more other operations may be added.

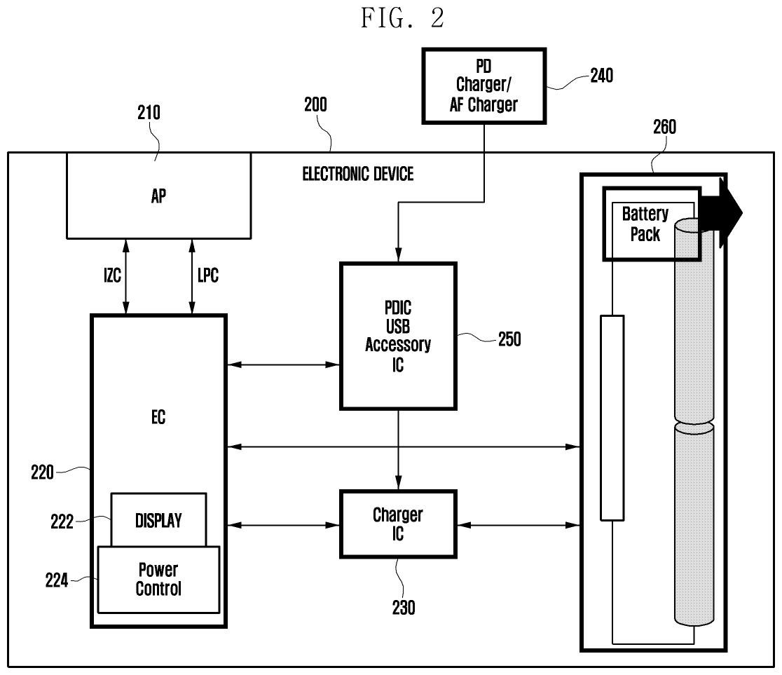

FIG. 2 is a block diagram illustrating a charging system of an electronic device according to an embodiment of the disclosure.

Referring to FIG. 2, an electronic device 200 according to the comparative example may include a processor 210, an embedded controller (EC) 220, a charger IC 230, a power delivery integrated circuit (PDIC) 250, and a battery 260.

Using the embedded controller (EC) 220, the electronic device 200 is capable of controlling at least one of power management, keyboard management, charger function management, or battery function management. The embedded controller (EC) 220 can always remain in operation (i.e., always on) when power is supplied using a charger. When variable charging power is supplied to a system, the electronic device 200 can operate the system by using the embedded controller (EC) 220 being in the always-on state and start charging and power management.

The electronic device 200 according to the comparative example can control power by using the power delivery integrated circuit (PDIC) 250 when a variable charger 240 is connected. Using the power delivery integrated circuit (PDIC) 250, the electronic device 200 can establish a communication connection with the variable charger 240. Using the power delivery integrated circuit (PDIC) 250, the electronic device 200 can identify information about the variable charger 240, including a type (e.g., whether wired or wireless) or charging capacity (e.g., 10 W). The electronic device 200 can operate the processor 210 by using the embedded controller (EC) 220 when the variable charger 240 is connected. Using the embedded controller (EC) 220, the electronic device 200 can supply power to the charger IC 230, the power delivery integrated circuit (PDIC) USB accessory IC 250, and the battery 260, and control charging to proceed while the system is turned off. When charging is performed with the system turned off, the electronic device 200 may use the embedded controller (EC) 220 to turn off the power of some circuits of the processor 210 that are not related to charging. The embedded controller (EC) 220 may include a display 222 and a power control circuit 224.

As the electronic device 200 uses the embedded controller (EC) 220, the complexity of internal circuits of the electronic device 200 may increase. In addition, the unit price of the electronic device 200 may increase due to failure or repair of the embedded controller (EC) 220.

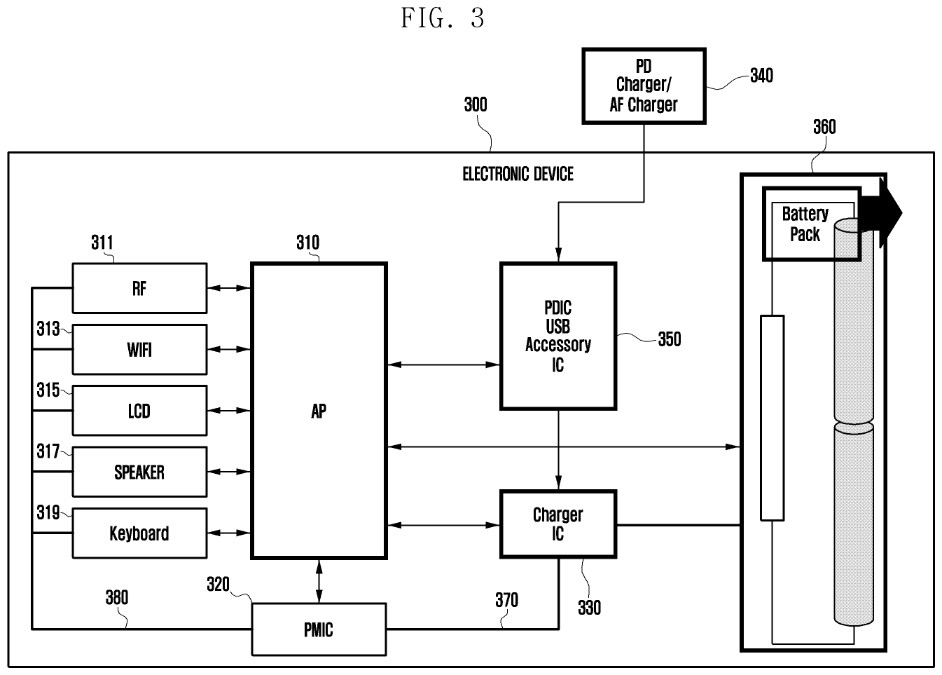

Additionally, the embedded controller (EC) 220 maintains the always-on state, so it may be difficult to turn off the power. In this case, leakage current may occur in the embedded controller (EC) 220 and nearby connected circuits while charging is performed with the system turned off. In the case that the embedded controller (EC) 220 is used, the processor 210 may remain in an off state. The electronic device 200 may display state information related to charging (e.g., various kinds of information including a charging error situation and/or battery capacity) on a display (e.g., the display circuit 160 in FIG. 1) in response to a user input. When displaying the state information related to charging while the processor 210 of the electronic device 200 is inactive, the electronic device 200 should use the processor 210, but a time delay may occur in the process of booting the processor 210 in the off state. Hereinafter, in FIG. 3, an electronic device in which the embedded controller (EC) 220 is removed and other hardware and software components are added to overcome the above issues of the electronic device 200 according to the comparative example will be described.

FIG. 3 is a block diagram illustrating a charging system of an electronic device according to an embodiment of the disclosure.

Referring to FIG. 3, an electronic device 300 according to various embodiments may include a processor 310, a power management integrated circuit (PMIC) 320, a charging circuit (charger IC) 330, a power delivery integrated circuit (PDIC) 350, and/or a battery 360.

Compared to an electronic device (e.g., the electronic device 200 in FIG. 2) according to a comparative example, the electronic device 300 according to various embodiments may not include the embedded controller (EC) 220 of FIG. 2.

According to an embodiment of the disclosure, the battery 360 may include a rechargeable battery and/or a solar battery. The battery 360 may refer to a means for providing power to each hardware and/or software of the electronic device 300 (e.g., the processor 310, the power management integrated circuit (PMIC) 320, the charging circuit (charger IC) 330, the power delivery integrated circuit (PDIC) 350, a radio frequency (RF) 311, a Wi-Fi 313, a liquid crystal display (LCD) 315, a speaker 317, and a keyboard 319). Alternatively, the battery 360 may provide power to each hardware of the electronic device 300, and the hardware may use the power received from the battery 360 to perform functions provided by software. The battery 360 may be located separately from the electronic device 300 or connected to the electronic device 300 and provide power to each hardware of the electronic device 300. In the embodiment of FIG. 3, for convenience of explanation, a path of providing power may be indicated by a solid line, and a path of providing signals or information may be indicated by a double-directional arrow. The battery 360 may provide power to the power management integrated circuit 320. The battery 360 may include a 2 serial 1 parallel (2S1P) battery in which two battery cells are connected in series.

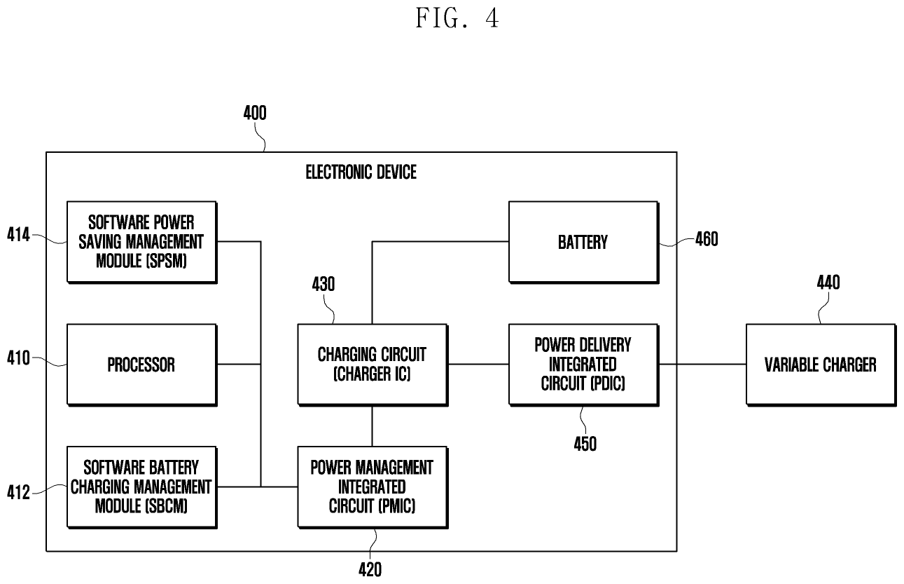

The power management integrated circuit 320 may manage power inputted 370 from the battery 360 and output 380 the power to each hardware of the electronic device 300, for example, a system (not shown). Additionally, the power management integrated circuit 320 may provide the power inputted 370 from the battery 360 to some hardware of the system (not shown). For example, all hardware of the electronic device 300 may not be used, only some hardware may operate, and the power management integrated circuit 320 may provide power from the battery 360 to only some hardware requested to operate and not to the remaining hardware. In addition, the power management integrated circuit 320 may regulate power and provide the regulated power to hardware, that is, the processor 310 or the system (not shown). Regulating may refer to the operation of adjusting the voltage to output a certain voltage or a voltage within a certain range. The detailed configuration of the power management integrated circuit 320 will be described with reference to FIG. 4.

The processor 310 may include at least one of a central processing unit (CPU), an application processor (AP), or a communication processor (CP). For example, the processor 310 may perform the data processing or computation related to the control and/or communication of at least one other component of the electronic device 300. The processor 310 may control the power management integrated circuit 320 and the system (not shown). In an embodiment of the disclosure, the processor 310 may determine the hardware to which the power management integrated circuit 320 will deliver power. For example, based on hardware usage information of a running application, the processor 310 may determine the hardware being used. In addition, using the power management integrated circuit 320, the processor 310 may control the power to be delivered to hardware being used and not to be delivered to hardware not being used.

Meanwhile, the processor 310 may receive a first signal generated from the charging circuit 330. The first signal may include at least one of information for controlling at least some functions of the processor 310, information for controlling at least some functions of an application executed by the processor 310, information for controlling at least some functions of at least one circuit (e.g., the RF 311, the Wi-Fi 313, the LCD 315, the speaker 317, and the keyboard 319) executed by the processor 310, and information for adjusting the amount of power supplied to the processor 310 from the power management integrated circuit 320. Using the received first signal, the processor 310 may control the power management integrated circuit 320, control at least some functions of an application, or restrict at least one circuit (e.g., the RF 311, the Wi-Fi 313, the LCD 315, the speaker 317, and the keyboard 319) executed by the processor 310. In addition, the processor 310 may adjust the power value delivered from the power management integrated circuit 320 to the system (not shown), particularly each hardware. Using a line, the charging circuit 330 may transmit the power to the power management integrated circuit 320. Using a line, the power management integrated circuit 320 may supply the power to at least one circuit selected from 311 to 319 connected to the processor 310.

According to an embodiment of the disclosure, the processor 310 is a component capable of performing the data processing or computation related to the control and/or communication of the respective components of the electronic device 300, and may be including one or more processors. The processor 310 may include at least some of the components and/or functions of the processor 120 shown in FIG. 1.

According to an embodiment of the disclosure, there will be no limitation to the data processing or computation functions that the processor 310 can implement on the electronic device 300, but hereinafter, features related to the control of hardware circuits, the control of software circuits, and the control of the power management integrated circuit 320 according to a charging mode will be described. The operations of the processor 310 may be performed by loading instructions stored in memory (not shown).

The electronic device 300 according to various embodiments of the disclosure is capable of distributing power by using the power management integrated circuit (PMIC) 320 rather than using the embedded controller (EC) 220 shown in FIG. 2. The charging circuit (charger IC) 330, the power delivery integrated circuit (PDIC) 350, and the battery 360 may be electrically connected to the processor 310. The electronic device 300 may further include a software power saving management circuit (SPSM) and a software battery charging management circuit (SBCM). The software power saving management circuit and the software battery charging management circuit are software and may not occupy a separate physical space in the electronic device 300. The electronic device 300 performs power management and battery state management by using the software power saving management circuit and the software battery charging management circuit, thereby reducing the complexity inside the electronic device 300 that may be caused by the embedded controller 220. The software power saving management circuit and the software battery charging management circuit will be described in FIG. 4.

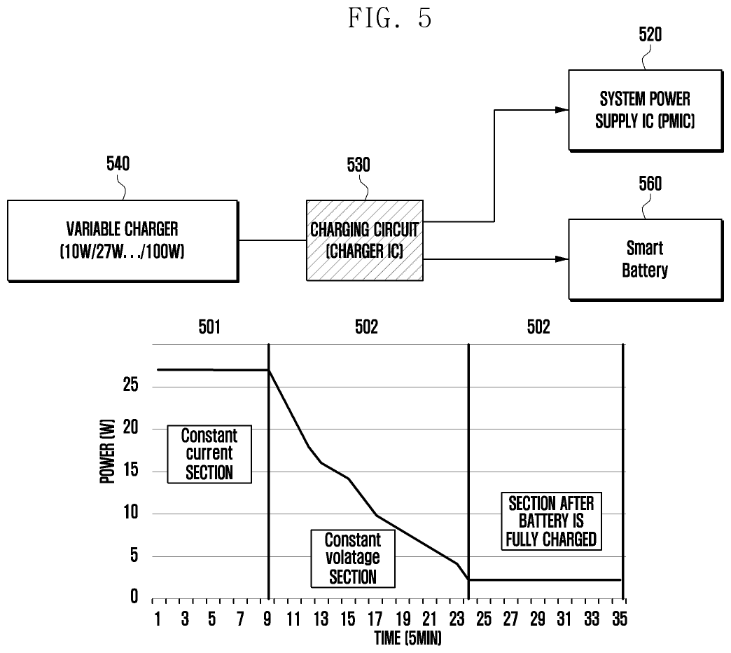

The electronic device 300 controls to supply power to the charging circuit (charger IC) 330 by using the variable charger 340 in a state where the system is turned off, and it may supply power to at least one of the system or the battery 360 by using the charging circuit (charger IC) 330. The variable charger 340 may include, for example, a power delivery charger or a fast charger. A process in which the electronic device 300 charges the system or the battery 360 by using the variable charger 340 will be described with reference to FIG. 5.

The electronic device 300 according to the disclosure does not include the embedded controller (EC) 220, and it may include the power management integrated circuit (PMIC) 320, which is a sort of hardware, and the power saving management circuit and the battery charging management circuit, which are sorts of software. The electronic device 300 is capable of controlling the charging process in a power-off state by using the processor 310 instead of the embedded controller 220 that is in an always-on state. At this time, the processor 310 may be maintained in a sleep or off state. In the case where charging is performed while the system of the electronic device 300 is turned off, the processor 310 can control a connected circuit to operate. While operating the circuit connected to the processor 310, the electronic device 300 may consume system current which may be classified as standby power. Even without using the embedded controller 220, the electronic device 300 can minimize the standby power of a plurality of circuits connected to the processor 310 by using the software power saving management circuit (SPSM). Additionally, even without using the embedded controller 220, the electronic device 300 can control the state and charging state of the battery by using the software battery charge management circuit (SBCM).

FIG. 4 is a block diagram illustrating an electronic device according to an embodiment of the disclosure.

Referring to FIG. 4, an electronic device 400 according to various embodiments may include a processor 410, a power management integrated circuit (PMIC) 420, a charging circuit 430, a power delivery integrated circuit (PDIC) 450, a battery 460, a software battery charging management circuit (SBCM) 412, and a software power saving management circuit (SPSM) 414.

According to an embodiment of the disclosure, the processor 410 is a component capable of performing the data processing or computation related to the control and/or communication of the respective components of the electronic device 400, and may be including one or more processors. The processor 410 may include at least some of the components and/or functions of the processor 120 of FIG. 1 or the processor 310 of FIG. 3.

The power management integrated circuit (PMIC) 420 may receive power from the charging circuit 430, convert it into a stable and efficient voltage or current, and distribute it inside the electronic device 400. The power management integrated circuit (PMIC) 420 may convert alternating current power into direct current power, convert voltage, switch the power received from the charging circuit 430 and then distribute it to other hardware or software, or remove noise. For example, the power management integrated circuit (PMIC) 420 may convert and supply voltage depending on the voltage required by the processor 410, memory (e.g., the memory 130 in FIG. 1), and a display circuit (e.g., the display circuit 160 in FIG. 1). The components of the electronic device 400 to which the power management integrated circuit (PMIC) 420 can supply voltage are not limited to this.

The battery charging management circuit 412 may establish a communication connection with the power saving management circuit 414 and, when charging is performed in the system off state of the electronic device 400, control the state of the battery 460 and a charging management function. For example, the battery charging management circuit 412 may transmit battery charging information including at least one of the voltage, current, temperature, or charging state of the battery to the processor 410. The processor 410 may identify the charging state of the battery 460 by using the battery charging management circuit 412 and display to the user whether an error has occurred or charging of the battery 460 has been completed. Alternatively, in response to a user input, the processor 410 may guide the charging level of the battery 460 on the display (e.g., the display circuit 160 in FIG. 1).

The power saving management circuit 414 may establish a communication connection with the battery charging management circuit 412 and minimize standby power of at least some of a plurality of circuits connected to the processor 410. For example, based on the charging state of the electronic device 400, the power saving management circuit 414 may maintain a Wi-Fi circuit (e.g., the Wi-Fi 313 in FIG. 3) in a deactivated (off) state and maintain an LCD circuit (e.g., the LCD 315 in FIG. 3) in an activated (on) state. The power saving management circuit 414 may identify the charging state of the battery 460 by using the battery charging management circuit 412 and, when the battery 460 is fully charged, display related information to the user. In this case, the power saving management circuit 414 needs to use the LCD circuit 315 to display information to the user that the battery 460 is fully charged, so the LCD circuit 315 may be kept in an activated state. The circuits that the power saving management circuit 414 can control are not limited to this, and whether or not circuits included in the electronic device 300 are activated may vary depending on the charging state or user input.

Using the battery charging management circuit 412, the processor 410 may identify the charging state of the battery 460. When the battery 460 is fully charged or close to it (e.g., 99.9% fully charged), the processor 410 may control the system voltage of the electronic device 400 to about 7V to 8V. In this case, the processor 410 may control power to be no longer supplied to the battery 460, and thereby control current consumption not to occur in the battery 460 and to occur only in the system of the electronic device 400.

According to an embodiment of the disclosure, in response to identifying that the charging state of the battery 460 is not a fully charged state by using the battery charging management circuit 412, the processor 410 may control the charging voltage to about 20V and control the charging current to about 5 A in using a charger 440.

According to an embodiment of the disclosure, in response to identifying that the charging state of the battery 460 is a fully charged state by using the battery charging management circuit 412, the processor 410 may control the system voltage of the electronic device 400 to about 7V and control the charging voltage and charging current of power supplied to the system of the electronic device 400 to about 5V and about 2 A.

According to an embodiment of the disclosure, in response to a user input, the processor 410 may boot to a basic input/output system (BIOS) screen and operate the system of the electronic device 400. Here, the user input may include an input of pressing a certain button (e.g., a power key, a volume control key) on the electronic device 400.

The processor 410 may control the voltage of the variable charger 440 to about 5V, which is lower than the system voltage. Alternatively, the processor 410 may control the voltage of the variable charger 440 to about 12V, which is higher than the system voltage. If the voltage of the variable charger 440 is lower than the system voltage, the electronic device 400 may execute a boost operation to raise the voltage in charging using the variable charger 440. Alternatively, if the voltage of the variable charger 440 is higher than the system voltage, the electronic device 400 may execute a buck operation to lower the voltage in charging using the variable charger 440. The current consumption in the system may increase as the voltage of the variable charger 440 increases. In this case, it may be efficient in terms of power consumption that the electronic device 400 maintains the voltage of the variable charger 440 relatively low compared to the system voltage. Therefore, when the charging state of the battery 460 is a full-charged state or close to it (e.g., 99.9% fully charged), the electronic device 400 may control the charging voltage of the variable charger 440 to about 5V, which is relatively lower than the system voltage.

FIG. 5 illustrates a charging process of an electronic device according to an embodiment of the disclosure.

Referring to FIG. 5, the electronic device (e.g., the electronic device 400 in FIG. 4) may be connected to a variable charger 540 to receive power. The variable charger 540 may supply power to a charging circuit 530. A processor (e.g., the processor 410 in FIG. 4) may identify the charging state of a battery 560 by using a battery charging management circuit (e.g., the battery charging management circuit 412 in FIG. 4) and, based on the charging state of the battery, control the charging circuit 530. For example, in response to identifying that the charging state of the battery 560 is not a full-charged state, the processor 410 may control the charging circuit 530 to supply power to the power management integrated circuit (PMIC) 520 and the battery 560. Alternatively, in response to identifying that the charging state of the battery 560 is a full-charged state, the processor 410 may control power to be supplied to the power management integrated circuit (PMIC) 520 and to be no longer supplied to the battery 560.

When the electronic device 400 includes one battery 560, the electronic device 400 may control charging of the battery 560 based on the voltage of the battery 560. For example, when the voltage of the battery 560 is less than a specified voltage (e.g., maximum charging voltage), the charging circuit 530 of the electronic device 400 may supply a constant current (CC) to the battery 560 (e.g., a constant current (CC) charging mode, a section 501). When the voltage of the battery 560 reaches the specified voltage, the electronic device 400 may maintain the level of voltage supplied to the battery 560 and reduce the level of current supplied to the battery 560 (e.g., a constant voltage (CV) charging mode, a section 502). Thereafter, in response to identifying that the charging state of the battery 560 is a full-charged state, in a section 503, the electronic device 400 may control constant power to be supplied to the power management integrated circuit (PMIC) 520 and control power to be no longer supplied to the battery 560.

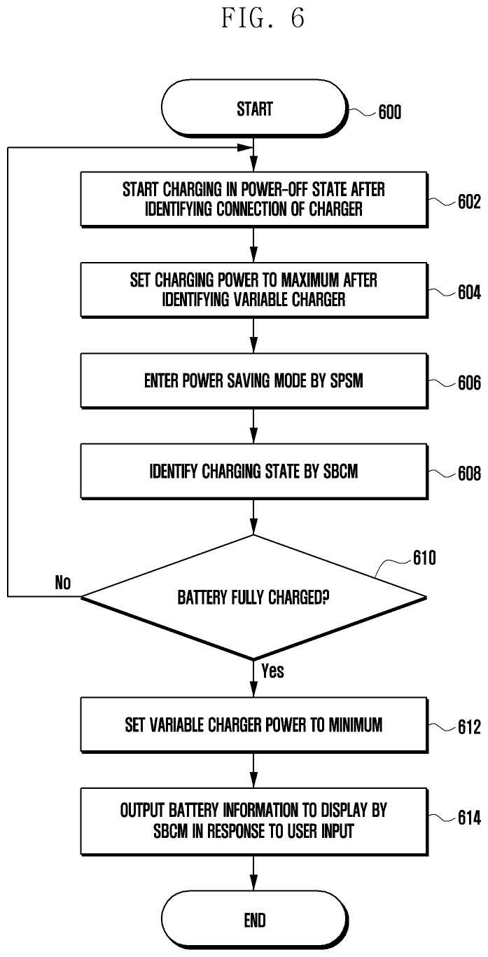

FIG. 6 is a flow chart illustrating a charging method of an electronic device according to an embodiment of the disclosure.

Referring to FIG. 6, the operations can be implemented based on instructions that can be stored in a computer recording medium or memory (130 in FIG. 1). The illustrated method 600 can be executed by the electronic device previously described with reference to FIGS. 1 to 5 (e.g., the electronic device 400 in FIG. 4), and technical features described above will be omitted below.

In operation 602, in response to identifying the connection of a charger (e.g., the variable charger 440 in FIG. 4), a processor (e.g., the processor 410 in FIG. 4) may control charging to be performed in a state of turning off the system of the electronic device 400.

In operation 604, in response to identifying the connection of the variable charger 440, the processor 410 may set the power to be charged using the variable charger 440 to the maximum. As previously described in FIG. 4, the processor 410 may control the voltage of the variable charger 440 to be about 5V, which is lower than the system voltage Alternatively, the processor 410 may control the voltage of the variable charger 440 to be about 12V, which is higher than the system voltage. If the voltage of the variable charger 440 is lower than the system voltage, the electronic device 400 may execute a boost operation to raise the voltage in charging using the variable charger 440. Alternatively, if the voltage of the variable charger 440 is higher than the system voltage, the electronic device 400 may execute a buck operation to lower the voltage in charging using the variable charger 440. The current consumption in the system may increase as the voltage of the variable charger 440 increases. In this case, it may be efficient in terms of power consumption that the electronic device 400 maintains the voltage of the variable charger 440 relatively low compared to the system voltage. However, when the charging state of a battery (e.g., the battery 460 in FIG. 4) is not a full-charged state, the processor 410 may control the charging voltage and charging current of the variable charger 440 to the maximum for fast charging. For example, in response to identifying that the charging state of the battery 460 is not a full-charged state, the processor 410 may control the charging voltage of the variable charger 440 to about 20V and control the charging current of the variable charger 440 to about 5 A. This is only an example, and the charging voltage and charging current values of the variable charger 440 are not limited to this.

In operation 606, a power saving management circuit (e.g., the power saving management circuit (SPSM) 414 in FIG. 4) may operate the electronic device 400 in a power saving mode. The power saving mode may refer to a mode for minimizing system power consumption, and the power saving management circuit 414 may control the operating state (e.g., on, off, sleep, wake up) of at least some of a plurality of circuits connected to the processor 410 in the power saving mode. For example, based on the charging state of the electronic device 400, the power saving management circuit 414 may maintain a Wi-Fi circuit (e.g., the Wi-Fi 313 in FIG. 3) in a deactivated (off) state and maintain an LCD circuit (e.g., the LCD 315 in FIG. 3) in an activated (on) state. The power saving management circuit 414 may identify the charging state of the battery 460 by using a battery charging management circuit (e.g., the battery charging management circuit (SBCM) 412 in FIG. 4) and, when the battery 460 is fully charged, display related information to the user. In this case, the power saving management circuit 414 needs to use the LCD circuit 315 to display information to the user that the battery 360 is fully charged, so the LCD circuit 315 may be kept in an activated state. As described in FIG. 4, the circuits that the power saving management circuit 414 can control are not limited to this, and whether or not each circuit is activated may vary depending on the charging state or user input.

In operation 608, the processor 410 may identify the charging state of the battery 460 by using the battery charging management circuit (SBCM) 412. According to an embodiment of the disclosure, the battery charging management circuit 412 may establish a communication connection with the power saving management circuit 414 and, when charging is performed in the system off state of the electronic device 400, control the state of the battery 460 and a charging management function. For example, the battery charging management circuit 412 may transmit battery charging information including at least one of the voltage, current, temperature, or charging state of the battery to the processor 410.

In response to identifying in operation 610 that the charging state of the battery 460 is not a full-charged state, the processor 410 may maintain the charging voltage and charging current of the variable charger 440 to the maximum (about 20V and about 5 A) in operation 604, and maintain the power saving mode by using the power saving management circuit 414 in operation 606. Alternatively, in response to identifying that the charging state of the battery 460 is or close to a full-charged state, the processor 410 may change the charging voltage and charging current of the variable charger 440 to the minimum in operation 612. Here, the minimum charging voltage of the variable charger 440 may be about 5V and the minimum charging current may be about 2 A.

According to an embodiment of the disclosure, the processor 410 may control the voltage of the variable charger 440 to be about 5V, which is lower than the system voltage. If the voltage of the variable charger 440 is lower than the system voltage, the electronic device 400 may execute a boost operation to raise the voltage in charging using the variable charger 440. The current consumption in the system may increase as the voltage of the variable charger 440 increases. In this case, it may be efficient in terms of power consumption that the electronic device 400 maintains the voltage of the variable charger 440 relatively low compared to the system voltage. Therefore, when the charging state of the battery 460 is a full-charged state or close to it (e.g., 99.9% fully charged), the electronic device 400 may control the charging voltage of the variable charger 440 to about 5V, which is relatively lower than the system voltage.

In operation 614, the processor 410 may identify the charging state of the battery 460 by using the battery charging management circuit (SBCM) 412 and display information related to the charging state of the battery 460 to the user. For example, when the battery 460 is fully charged, the processor 410 may provide the user with a guide indicating that charging is completed. Additionally, in response to identifying that an error has occurred in a charging process of the battery 460, the processor 410 may provide a guide indicating that an issue has occurred in the charging process. Alternatively, in response to a user input, the processor 410 may display the charging state of the battery 460 on a display (e.g., the display circuit 160 in FIG. 1).

An electronic device according to various embodiments may include a battery that supplies power to the electronic device, a power management integrated circuit (PMIC) that controls power required in the electronic device, a software battery charging management circuit that performs a charging management function of the battery, a software power saving management circuit that manages standby power of a plurality of circuits in the electronic device, memory storing one or more computer programs, and one or more processors communicatively coupled to the battery, the PMIC, the software battery charging management circuit, and software power saving management circuit, wherein the one or more computer programs include computer-executable instructions that, when executed by the one or more processors, cause the electronic device to, in response to identifying that a charger is connected to the electronic device, boot a system of the electronic device, control at least one circuit in the electronic device to operate in a sleep state for power saving by using the software power saving management circuit, and charge the battery while the system of the electronic device is in an off state. The processor may, in response to identifying that a charging state of the battery is not a fully charged state, charge the battery with a first voltage and/or a first current. The processor may, in response to identifying that the charging state of the battery is the fully charged state, block power supply to the battery, and control power to be supplied with a second voltage set lower than the first voltage and/or a second current set lower than the first current to at least one circuit in the electronic device, and wherein the software battery charging management circuit and/or the software power saving management circuit may be implemented in the one or more processors.

According to an embodiment of the disclosure, the one or more computer programs further include computer-executable instructions that, when executed by the one or more processors, cause the software power saving management circuit of the electronic device to control whether to operate (on/off) at least one circuit operatively connected to the processor in response to identifying that the system of the electronic device is charged in the off state.

According to an embodiment of the disclosure, the one or more computer programs further include computer-executable instructions that, when executed by the one or more processors, cause the software power saving management circuit of the electronic device to control at least one circuit operatively connected to the processor to a sleep state in response to identifying that the system of the electronic device is charged in the off state, and control the circuit being in the sleep state to wake up in response to a user input.

According to an embodiment of the disclosure, the one or more computer programs further include computer-executable instructions that, when executed by the one or more processors, cause the PMIC of the electronic device to distribute power to the processor and at least one circuit operatively connected to the processor.

According to an embodiment of the disclosure, the electronic device may further include a display. The software battery charging management circuit may transmit charging information of the battery to the processor in response to identifying that charging is performed in a system power off state of the electronic device, and the processor may guide the charging information of the battery on the display in response to a user input.

According to an embodiment of the disclosure, the charging information of the battery may include at least one of charging state, temperature, charging current, or charging voltage of the battery.

According to an embodiment of the disclosure, the first voltage may include about 20V, the first current may include about 5 A, the second voltage may include about 5V, and the second current may include about 2 A.

According to an embodiment of the disclosure, the sleep state may refer to a state in which operation is possible in response to a user input while the system of the electronic device is turned off.

According to an embodiment of the disclosure, the one or more computer programs further include computer-executable instructions that, when executed by the one or more processors, cause the electronic device to boot to a basic input/output system (BIOS) screen in response to a user input and operate the system of the electronic device.

According to an embodiment of the disclosure, the electronic device may further include a power delivery integrated circuit (PDIC). The one or more computer programs further include computer-executable instructions that, when executed by the one or more processors, cause the electronic device to establish a communication connection with the charger connected to the electronic device by using the PDIC, and receive charger information including a type or charging capacity of the charger.

A charging method of an electronic device may include, in response to identifying that a charger is connected to the electronic device, booting a system of the electronic device, causing at least one circuit in the electronic device to enter a sleep state for power saving by using a software power saving management circuit that manages standby power of a plurality of circuits in the electronic device, and charging a battery that supplies power to the electronic device while the system of the electronic device is in an off state, in response to identifying that a charging state of the battery is not a fully charged state, charging the battery with a first voltage and/or a first current, and in response to identifying that the charging state of the battery is the fully charged state, blocking power supply to the battery, and controlling power to be supplied with a second voltage set lower than the first voltage and/or a second current set lower than the first current to at least one circuit in the electronic device. The electronic device further includes a software battery charging management circuit, that performs a charging management function of the battery, and/or the software power saving management circuit may be implemented in one or more processors.

According to an embodiment of the disclosure, the method of the electronic device may further include transmitting charging information of the battery to the processor in response to identifying that charging is performed in a system power off state of the electronic device, and guiding the charging information of the battery on a display in response to a user input.

According to an embodiment of the disclosure, the method of the electronic device may further include booting to a basic input/output system (BIOS) screen in response to a user input and operating the system of the electronic device.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software circuits), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a battery that supplies power to the electronic device;
a power management integrated circuit (PMIC) that controls power required in the electronic device;
a software battery charging management circuit that performs a charging management function of the battery;
a software power saving management circuit that manages standby power of a plurality of circuits in the electronic device;
memory storing one or more computer programs; and
one or more processors communicatively coupled to the battery, the PMIC, the software battery charging management circuit, and software power saving management circuit,
wherein the one or more computer programs include computer-executable instructions that, when executed by the one or more processors, cause the electronic device to:
in response to identifying that a charger is connected to the electronic device, boot a system of the electronic device, control at least one circuit in the electronic device to operate in a sleep state for power saving by using the software power saving management circuit, and charge the battery while the system of the electronic device is in an off state,
in response to identifying that a charging state of the battery is not a fully charged state, charge the battery with a first voltage and/or a first current, and
in response to identifying that the charging state of the battery is the fully charged state, block power supply to the battery, and control power to be supplied with a second voltage set lower than the first voltage and/or a second current set lower than the first current to at least one circuit in the electronic device, and
wherein the software battery charging management circuit and/or the software power saving management circuit are/is implemented in the one or more processors.

2. The electronic device of claim 1, wherein the one or more computer programs further include computer-executable instructions that, when executed by the one or more processors, cause the software power saving management circuit of the electronic device to:
control whether to operate (on/off) at least one circuit operatively connected to the one or more processors in response to identifying that the system of the electronic device is charged in the off state.

3. The electronic device of claim 1, wherein the one or more computer programs further include computer-executable instructions that, when executed by the one or more processors, cause the software power saving management circuit of the electronic device to:
control at least one circuit operatively connected to the one or more processors to a sleep state in response to identifying that the system of the electronic device is charged in the off state, and
control the circuit being in the sleep state to wake up in response to a user input.

4. The electronic device of claim 1, wherein the one or more computer programs further include computer-executable instructions that, when executed by the one or more processors, cause the PMIC of the electronic device to:
distributes power to the one or more processors and at least one circuit operatively connected to the one or more processors.

5. The electronic device of claim 1, further comprising:
a display,
wherein the one or more computer programs further include computer-executable instructions that, when executed by the one or more processors, cause the software battery charging management circuit of the electronic device to transmit charging information of the battery to the one or more processors in response to identifying that charging is performed in a system power off state of the electronic device, and
wherein the one or more computer programs further include computer-executable instructions that, when executed by the one or more processors, cause the electronic device to guide the charging information of the battery on the display in response to a user input.

6. The electronic device of claim 5, wherein the charging information of the battery includes at least one of charging state, temperature, charging current, or charging voltage of the battery.

7. The electronic device of claim 1, wherein the first voltage includes about 20V, the first current includes about 5 A, the second voltage includes about 5V, and the second current includes about 2 A.

8. The electronic device of claim 1, wherein the sleep state refers to a state in which operation is possible in response to a user input while the system of the electronic device is turned off.

9. The electronic device of claim 1, wherein the one or more computer programs further include computer-executable instructions that, when executed by the one or more processors, cause the electronic device to boot to a basic input/output system (BIOS) screen in response to a user input and operates the system of the electronic device.

10. The electronic device of claim 1, further comprising:
a power delivery integrated circuit (PDIC),
wherein the one or more computer programs further include computer-executable instructions that, when executed by the one or more processors, cause the electronic device to:
establish a communication connection with the charger connected to the electronic device by using the PDIC, and
receive charger information including a type or charging capacity of the charger.

11. A charging method of an electronic device, the method comprising:
in response to identifying that a charger is connected to the electronic device, booting a system of the electronic device;
causing at least one circuit in the electronic device to enter a sleep state for power saving by using a software power saving management circuit that manages standby power of a plurality of circuits in the electronic device, and charging a battery that supplies power to the electronic device while the system of the electronic device is in an off state;
in response to identifying that a charging state of the battery is not a fully charged state, charging the battery with a first voltage and/or a first current; and
in response to identifying that the charging state of the battery is the fully charged state, blocking power supply to the battery, and controlling power to be supplied with a second voltage set lower than the first voltage and/or a second current set lower than the first current to at least one circuit in the electronic device,
wherein the electronic device further includes a software battery charging management circuit, that performs a charging management function of the battery, and/or the software power saving management circuit are/is implemented in one or more processors.

12. The method of claim 11, further comprising:
controlling, by the software power saving management circuit, whether to operate (on/off) at least one circuit operatively connected to the one or more processors in response to identifying that the system of the electronic device is charged in the off state.

13. The method of claim 11, further comprising:
controlling, by the software power saving management circuit, at least one circuit operatively connected to the one or more processors to a sleep state in response to identifying that the system of the electronic device is charged in the off state, and
controls the circuit being in the sleep state to wake up in response to a user input.

14. The method of claim 11, further comprising:
distributing, by a power management integrated circuit (PMIC) that controls power required in the electronic device, power to the one or more processors and at least one circuit operatively connected to the one or more processors.

15. The method of claim 11, further comprising:
transmitting charging information of the battery to the one or more processors in response to identifying that charging is performed in a system power off state of the electronic device; and
guiding the charging information of the battery on a display in response to a user input.

16. The method of claim 15, wherein the charging information of the battery includes at least one of charging state, temperature, charging current, or charging voltage of the battery.

17. The method of claim 11, wherein the first voltage includes about 20V, the first current includes about 5 A, the second voltage includes about 5V, and the second current includes about 2 A.

18. The method of claim 11, further comprising:
establishing, by a power delivery integrated circuit (PDIC) included in the electronic device, a communication connection with the charger connected to the electronic device by using, and
receiving charger information including a type or charging capacity of the charger.

19. One or more non-transitory computer-readable storage media storing computer-executable instructions that, when executed by one or more processors of an electronic device, cause the electronic device to perform operations, the operations comprising:
in response to identifying that a charger is connected to the electronic device, booting a system of the electronic device;
causing at least one circuit in the electronic device to enter a sleep state for power saving by using a software power saving management circuit that manages standby power of a plurality of circuits in the electronic device, and charging a battery that supplies power to the electronic device while the system of the electronic device is in an off state;
in response to identifying that a charging state of the battery is not a fully charged state, charging the battery with a first voltage and/or a first current; and
in response to identifying that the charging state of the battery is the fully charged state, blocking power supply to the battery, and controlling power to be supplied with a second voltage set lower than the first voltage and/or a second current set lower than the first current to at least one circuit in the electronic device,
wherein the electronic device further includes a software battery charging management circuit, that performs a charging management function of the battery, and/or the software power saving management circuit are/is implemented in one or more processors.

20. The one or more non-transitory computer-readable storage media of claim 19, the operations further comprising:
controlling, by the software power saving management circuit, whether to operate (on/off) at least one circuit operatively connected to the one or more processors in response to identifying that the system of the electronic device is charged in the off state.
